(19) United States
(12) Patent Application Publication
(10) Pub. No.: US 2008/0320264 A1
(43) Pub. Date: Dec. 25, 2008

(54) CHIP CARD PROTECTED AGAINST COPYING AND METHOD FOR PRODUCTION THEREOF

(76) Inventors: Michael Bungert, Neuried (DE); Manfred Hahn, Neubeuern (DE); Markus Heintel, Muenchen (DE)

Correspondence Address: SCHIFF HARDIN, LLP;PATENT DEPARTMENT, 6600 SEARS TOWER, CHICAGO, IL, 60606-6473, US

(21) Appl. No.: 12/057,473

(22) Filed: Mar. 28, 2008

Related U.S. Application Data
(60) Provisional application No. 60/921,098, filed on Mar. 30, 2007.

(30) Foreign Application Priority Data
Mar. 29, 2007 (DE) 10 2007 015 228.2

(51) Int. Cl. G06F 12/14

(52) U.S. Cl. 711/164; 711/E12.094

(57) ABSTRACT

A chip card is protected against copying by having a data memory for storage of data that are protected, at least in a sub-region of the data memory, against alteration by users or attackers outside of a privileged group. Members of this group can write an individual identifier for this chip card into this protected memory region once, and can write a digital signature of this identifier to an arbitrary memory region of the data memory. The digital signature can be generated with the use of a secret key for which an associated public key exists with which it can be checked whether the digital signature was generated from the individual identifier with the use of a secret key.

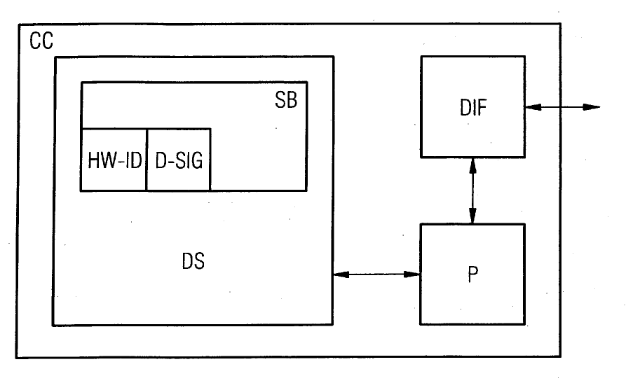

### RELATED APPLICATION

The present application claims the benefit of the filing date of provisional application 60/921,098, filed Mar. 30, 2007.

### BACKGROUND OF THE INVENTION

1. Field of the Invention

The present invention concerns a chip card with a data memory for storage of data, a method for production of such a chip card, a method for setting up a copy protection for a chip card produced according to such a method and a method for supporting the authenticity check in connection with a chip card produced or set up according to any of the aforementioned methods.

2. Description of the Prior Art

Chip cards today play a central role in many fields in daily life as data media for security-critical information in connection with applications such as payment, access control or other applications such as, for example, the patient card (which is also designated as an electronic health insurance card). Because these chip cards carry security-critical information, it is required for these chip cards to be protected against copying, i.e. against an illegal production of a functionally identical copy of the legally issued chip card. Such an illegal copying is also colloquially called as “cloning”.

### SUMMARY OF THE INVENTION

An object of the present invention is to provide a solution to the above problem.

The above object is achieved in accordance with the present invention by a chip card with a data memory for the storage of data therein, the data being protected at least in a region thereof against alteration by persons outside of a privileged group, but that allows persons within the privileged group to write data once into the protected memory region, and wherein an individual identifier for the chip card is stored in the protected memory region and a digital signature of this identifier, and possible further date, are stored in an arbitrary region of the data memory.

The above object also is achieved in accordance with the present invention by a method for the production of a chip card including the steps of providing a protected region in a data memory of a chip card by protecting the region against access by persons outside of a privileged group, writing an individual identifier into the protected memory region of the chip card, and writing a digital signature of the individual identifier, and possibly further data, into an arbitrary memory region of the chip card.

### BRIEF DESCRIPTION OF THE DRAWINGS

The FIGURE shows in a schematic manner the basic architecture of an inventive chip card according to a preferred exemplary embodiment.

### DESCRIPTION OF THE PREFERRED EMBODIMENTS

The inventive chip card CC presented schematically in an exemplary embodiment has a data memory DS that contains at least one protected region SB in which are stored the inventive individual identifier (HW-ID) of the chip card and the digital signature (D-SIG). It is not absolutely necessary, however, for the signature of the individual identifier is stored in a protected memory region SB of the chip card. Depending on the application case it can be advantageous to provide separate memory regions for both data that can also be realized differently in terms of technology (for example as a ROM, EPROM etc.), of which only the memory region in which the individual identifier (HW-ID) of the chip card is stored must be protected.

As used herein, a “protected memory region SB” means a memory region protected against an alteration by users or attackers outside of a privileged group. According to regulations, data may only be written in this protected memory region once by members of the privileged group. Any attempt by users or attackers outside of this privileged group to access this protected memory region by writing to it or altering it in any way must, according to regulation, be prevented by suitable measures.

This protection of the memory region SB can be realized technically in various ways:

In the preferred embodiment shown in the FIGURE, in which the chip card also has a processor P that can limit the access (via the interface DEF) to the data memory on the chip card in a controlled manner, the protection of the memory region to be protected can also be achieved by suitable measures in the responsible program logic. The program controlling and limiting the memory access is normally a part of the chip card operating system that is normally located in a permanent memory ROM on the chip card and is stored in this permanent memory in the production of the chip card such that it cannot be altered. Due to the invariability of this program, given suitable selection of the program logic it is ensured that the memory regions SB (in which the data to be protected are stored) that are to be protected can only be accessed by members of the privileged group in the first-time writing of these regions. After this, any write access to the protected regions is impossible. This type of memory protection could be designated as software protection.

This possibility is precluded in other cases in which the chip card does not possess a processor (thus is a mere memory card). The protection of the memory regions to be protected can therefore only be achieved via technological measures of the memory production. Those skilled in the art are familiar with a range of memory technologies with which it can be ensured that every memory element of such a memory can only be written to once (advantageously in the production process) and that any attempt to write data to the same memory cells a second time leads to the destruction or inoperability of the memory cells.

In principle any memory technology that satisfies the cited requirements is suitable for realization of the invention in this embodiment.

In order to further increase the security of the first embodiment variant with the processor that regulates the memory access, the limitation of the memory access via the software of the processor can be combined with the memory technology.

A preferred possibility for generation of a digital signature (D-SIG) of the individual identifier (HW-ID) of a chip card is the use of a secret key (S-KEY) for which an associated public key (P-KE) exists with which it can be checked whether the digital signature D-SIG was generated from the individual identifier (HW-ID) with the aid of a secret key S-KEY. In principle any asymmetrical cryptographic method in which a key pair is used whose public key does not need to be kept secret is suitable for this.

An asymmetrical cryptographic system is a cryptographic system in which each of the communicating parties possesses a key pair that comprises a secret key (private key) and a non-secret key (public key). The private key enables its owner to encrypt data, generate or authenticate digital signatures, for example. The public key enables anyone to encrypt data for the key owner, to check his digital signatures or to authenticate him. In contrast to a symmetrical cryptographic system, the communicating parties do not have to know any common secret key. Asymmetrical cryptographic systems are therefore also designated as public key methods.

An important example for an asymmetric cryptographic method is the RSA method, which can be used both for encryption and for digital signatures. It employs a key pair comprising a private key that is used for decrypting or signing of data and a public key with which one encrypts or checks signatures. The private key is kept secret and cannot be calculated from the public key or can only be calculated with extremely high expenditure. RSA is named after its inventors Ronald L. Rivest, Adi Shamir and Leonard Adleman.

Various asymmetrical cryptographic methods are known to those skilled in the art. For example, the foundations for these methods are available in “Handbook of Applied Cryptography”, A. J. Menezes, P. C. van Oorschot, S. A. Vanstone, CRC Press, 1996.

If a third party now wants to check whether a chip card presented to him (which chip card is protected against unauthorized copying according to the present invention) is real or not, this third party reads the individual identifier HW-ID of the chip card and the digital signature D-SIG stored on it. To check the authenticity he then obtains the public key P-KEY with which the digital signature D-SIG was generated. By decryption of the digital signature D-SIG with the aid of the public key P-KEY, an individual identifier HW-ID′ arises that the checking party can compare with the individual identifier HW-ID stored on the chip card. Given agreement of the two the chip card is real, meaning that the individual identifier of the chip card HW-ID was signed with the aid of a secret key which matches the public key which the checking party used.

Since only members of the privileged groups can possess the secret key S-KEY used to generate the signature D-SIG stored on the chip card, the checked chip card can only have been signed by a member of the privileged group. This can be viewed as an authenticity verification.

Only a read access to the data in the secured memory region of the chip card is thus required to check the authenticity. By contrast, a write access in which the individual identifier and the associated signature of a real chip card would simply be written to the memory of a chip card blank by the forger would be required to forge a chip card, i.e. to produce an unauthorized copy. The chip card could be duplicated in this manner if a write access to the corresponding memory regions were possible. However, this is directly prevented by the security precautions described above.

In many application cases it is desirable that the signature of the individual identifier of a chip card is not affected by the same instance that also applies the individual identifier to the chip card. This is desirable when, for example, a chip card should not only be able to be protected from copying but rather should also be able to be associated with a canceled group of chip cards with the aid of the signature. Another such case would exist if the issue of the chip card incorporates not only the individual identifier HW-ID but also further features (for example identification features of the card issuer of the group etc.) into the signature.

In these or similar cases it should thus be possible that the individual identifier HW-ID is applied to the chip card by the manufacturer of the chip card, i.e. is written by said manufacturer into the secured memory region. By contrast, in these application cases the signature should be generated not by the manufacturer but rather by the chip card issuers, for example, and be written into a memory region of the chip card. For example, this is easily possible when a protected memory region is executed as a permanent value memory that can be programmed once electrically or via masking in the chip production by the manufacturer. In this case it is easily possible for the chip manufacturer to directly program the individual identifier of a chip into the permanent value memory (ROM) in or after the production of said permanent value memory (ROM).

In order to further increase the security, this permanent value memory in which the individual identifier of the chip is stored could be provided separate from another secured or unsecured memory region SB′ in which the chip card issuer (the issuer) can write the signature D-SIG later. This second secured memory region SB′ in which the chip card issuer can write the signature can also be designed as an electrically programmable permanent value memory (E-PROM). However, it is important that a new write access to this permanent value memory is not possible or is only possible while destroying the memory, at least in the cases in which the access to the memory is not limited and regulated by a processor. By contrast, a read access should always also be possible later.

Because a public key is required for checking given a check of the authenticity of the chip card (at least in the cases in which the signature was generated with the aid of a secret key), it is also advantageous when information about how the third party determined to check the authenticity of the chip card can obtain the public key P-KEY is stored in a further memory region on the inventive chip card. This information could be, for example, a reference (known as a “LINK”) to a network address in which the public key is stored. Since this key is public (commensurate with its name), there exists no requirement whatsoever to protect this key from read accesses by third parties.

Although modifications and changes may be suggested by those skilled in the art, it is the intention of the inventors to embody within the patent warranted hereon all changes and modifications as reasonably and properly come within the scope of their contribution to the art.

We claim as our invention:

1. A chip card comprising:
a data memory for storage of data therein;
at least a portion of said data memory comprising a protected region that is protected against alteration of data therein by persons outside of a privileged group, but that allows members of the privileged group to write data once into the protected memory region;
said protected memory region having an individual identifier for the chip card stored therein; and
said data memory also having a digital signature of the individual identifier stored therein in an arbitrary region of the data memory.

2. A chip card as claimed in claim 1 within said data memory contains further data stored in said arbitrary region of said data memory.

3. A chip card as claimed in claim 1 wherein said digital signature comprises a digital signature generated using a secret key having an associated public key allowing a check to be made as to whether the digital signature was generated from said individual identifier using said secret key.

4. A chip card as claimed in claim 3 wherein said data memory contains data in a memory region required for checking whether said digital signature was generated using said secret key from said individual identifier.

5. A chip card as claimed in claim 1 wherein said data memory comprises a data memory having said individual identifier unalterably programmed into said protected region by a manufacturer of the chip card, and wherein said digital signature comprises a digital signature stored in said arbitrary region of said data memory by an issuer of the chip card, subsequent to manufacture of said chip card, before issuance of the chip card to a user.

6. A method for producing a chip card comprising the steps of:
protecting a protected region of a data memory in a chip card against alteration of data in the protected region by persons outside of a privileged group;
writing an individual identifier for the chip card into said protected region of said data memory; and
storing a digital signature of said identifier in an arbitrary region of said data memory.

7. A method as claimed in claim 6 comprising generating said digital signature using a secret key having an associated public key, and storing data in a further region of said memory allowing a check to be made as to whether the digital signature was generated from the individual identifier using said secret key.

8. A method as claimed in claim 7 comprising writing said individual identifier into said protected region of said data memory during manufacture of the chip card by a manufacturer, and storing said further data in said data memory, allowing said checking, at a time following manufacture of said chip card and before issuance of the chip card to a user thereof.
